(19) United States
(12) Patent Application Publication
(10) Pub. No.: US 2015/0286994 A1
(43) Pub. Date: Oct. 8, 2015

(54) "Method of Tracking and Reporting Vehicle Maintenance"

(71) Applicant: Ramon Elder, Denver, CO (US)

(72) Inventor: Ramon Elder, Denver, CO (US)

(21) Appl. No.: 14/681,734

(22) Filed: Apr. 8, 2015

Related U.S. Application Data
(60) Provisional application No. 61/976,655, filed on Apr. 8, 2014.

(51) Int. Cl. G06Q 10/00; G06F 17/30

(52) U.S. Cl. CPC G06Q 10/20; G06F 17/30876; G06F 17/30203

(57) ABSTRACT

A system and method of tracking and reporting vehicle maintenance. The system includes a database that stores vehicle maintenance records. The database may be accessed, reviewed, or modified by vehicle owners, maintenance facility technicians, and other registered users. Vehicle owners may receive an alert whenever a vehicle maintenance record is added to the system for the owner's vehicle. The owner can review the maintenance record for errors and discrepancies and may dispute maintenance records with the service facility or a system administrator.

### CROSS REFERENCE TO RELATED APPLICATION

This application claims the benefit of U.S. Provisional Patent Application Ser. No. 61/976,655, filed Apr. 8, 2014, the entire disclosure of which is incorporated by reference herein.

### FIELD OF THE INVENTION

The embodiments of the present invention relate generally to systems and methods of tracking and reporting vehicle maintenance.

### BACKGROUND

Cars, trucks, and other vehicles are safer and more reliable when they are properly serviced and maintained. Thus, vehicle manufacturers recommend frequent periodic vehicle maintenance at certain times, after predetermined time intervals, and when certain mileages are attained. Performing recommended or required periodic vehicle maintenance may also be required to comply with warranty requirements, leasing agreements, insurance requirements, and government safety or registration requirements. Proof of vehicle service and maintenance may also increase vehicle resale value. Performing maintenance at the recommended vehicle mileage or vehicle age requires the owner to keep meticulous records to ensure that required service has been performed and future service events are not missed. Thus, keeping accurate, reliable, and accessible records of a vehicle's service history is difficult.

Often, some vehicle owners maintain paper records of the service history of their vehicles. Paper records can be lost or misplaced and can be confusing. Paper service history records are frequently kept at the owner's residence and are therefore not generally accessible for review by a service technician of a service center which has not previously serviced the vehicle. The owner may also not be able to quickly access service records if the owner's vehicle unexpectedly requires service. Finally, even when paper records are kept, they are frequently incomplete and are not easy to search or review.

Some service centers maintain service history records of vehicles the service center has serviced. This may be acceptable if a vehicle owner always uses the same service center or a franchisee of one service center franchise. As briefly mentioned above, these records may not be accessible by the vehicle owner, by other service centers, or by difference franchises. Therefore, the records may be of little value or use if the vehicle owner visits a different service center. In addition, the owner may not be able to consolidate electronic records from different service centers or franchises to compile a comprehensive and complete vehicle service record.

This lack of complete or accessible vehicle service records may result in the vehicle owner paying for service that is not required or failing to perform service that is required. Additionally, automotive service technicians may have difficulty conveying to customers why certain recommended service is required and desirable. Further, with respect to vehicle resale, records maintained by the vehicle owner may not be reliable and could be altered to show certain maintenance was performed that was not actually performed.

Accordingly, there is an unmet need for a method of tracking and reporting vehicle maintenance that creates a comprehensive history of a vehicle's maintenance history that is accurate, reliable, and accessible by vehicle owners and service centers.

### SUMMARY OF THE INVENTION

Accordingly, embodiments of the present invention provide a novel system, device, and method for tracking and recording vehicle maintenance. One embodiment of the present invention provides a system for tracking and recording vehicle maintenance that includes one or more computers, a network, a web server, a file server and an application server, and a database in communication with the one or more computers, the network, the web server, and the file and application server. The contemplated system allows an end user to create an account with the system, register a vehicle in the system, enter information about the vehicle into the database, and enter vehicle maintenance information about the vehicle into the database. The contemplated system is accessible by other authorized users, which may encompass a service provider that is different from the original service provider, and by individuals interested in purchasing a used vehicle, for example.

One aspect the present invention is to provide a system that collects service records associated with a vehicle from the vehicle owners and service facilities and stores such information in a centralized database. The contemplated database may store information such as, but not limited to: 1) vehicle identification number associated with a service event; 2) vehicle information such as make, model, color, mileage, and attributes; 3) date that services were provided; 4) type of service; 5) service technician; 6) service location; 7) parts used, part origin, and warranty information; and 8) images, receipts, or attachments pertinent to the service event. The contemplated system can also collect information related to the vehicle from databases of vehicle manufacturers, parts manufacturers and suppliers, and government agencies.

It is another aspect of the present invention to allow the general public to access vehicle records stored by the system. More specifically, one embodiment of the present invention allows users to sign up for an account for the system via a website, an application (or “an app”) running on a mobile device, etc. The account will allow the user to access predefined vehicle service records. In one embodiment of the present invention, the vehicle owner may allow third-party access to the vehicle service records. Such access can be given to the general public, to specific individuals, to classes of individuals and subsets thereof, to vehicle service professionals, or to a particular vehicle service professional. The vehicle owners may also be able to register their vehicles into the system and enter maintenance that was personally performed on the vehicle by the vehicle owner. Such inputs could also include the information such as described above (e.g., pictures, receipts, descriptions of the work performed). The website also allows users to view vehicle manufacturer recommended preventative and periodic maintenance schedules for a vehicle. In summary, by means of the present invention, email or text reminders may be sent to the vehicle owner regarding when maintenance is due. The website may also allow a user to review information in the master database of the system related to the user's vehicle, including maintenance records regardless if entered by previous owners, themselves, or by service centers using the contemplated tracking system of the present invention. The contemplated website may also allow the user to identify local service shops and service centers that employ the system of embodiments of the present invention. As mentioned above, the website may be accessible via an app running on a mobile device.

In yet another aspect of the present invention, a non-transitory computer readable medium is provided. The computer readable medium has computer-executable instructions stored thereon and executable by a processor of a vehicle tracking and maintenance system. The computer-executable instructions cause the processor to execute a method and include, but are not limited to: (1) instructions to receive a registration request from a service facility; (2) instructions to create an account for the service facility in the system; (3) instructions to receive a request for a vehicle record of a vehicle from the service facility; (4) instructions to determine if a database of the system includes the vehicle record; (5) if the database includes the vehicle record, instructions to present the vehicle record to the service facility; (6) if the database does not include the vehicle record, instructions to create the vehicle record for the vehicle in the database, wherein the vehicle record includes first information received from the service facility; and (7) instructions to modify the vehicle record with second information received from the service facility after the service facility performs service on the vehicle, wherein the second information includes at least one of a type of service performed, a part installed on the vehicle, and a receipt for the service performed. In one embodiment, the instructions further include instructions to waive a registration fee and a subscription fee after determining that the registration request is from a service facility.

As briefly mentioned above, in one embodiment, the system includes a database that is accessible by a website or by an app running on a mobile device. The database may be accessible by third parties who are not the owner of a registered vehicle. Thus, the system allows potential vehicle buyers to register with the system and purchase a subscription plan that allows the potential vehicle buyer to search for and view vehicle service records from the database based on vehicle identification number. In another embodiment of the present invention, a potential vehicle buyer may view vehicle service records for all vehicles for sale within a certain defined area, or view service records for a subset of such vehicles based on a model, a make, a year of manufacture, or a grade of vehicle. In one embodiment of the present invention, third parties may have access to: 1) the vehicle service record history; 2) the maintenance performed on a vehicle including the date, location, and technician performing service and a receipt for that service; 3) the parts used to perform repairs and the manufacturer and warranty status of the parts; and 4) a grade representing the quality and perceived health of the vehicle, which is obtained through a predetermined algorithm using various data points for the vehicle obtained through the master database.

The service facilities that subscribe to the system and that service a vehicle registered in the system will be allowed to access records of service performed on the vehicle by other service facilities, the vehicle owner, or previous owners. Subscribing service facilities can also create a new record in the database for a vehicle that was not previously registered in the system. The service records may be automatically imported into the service provider's computer system when requested or on a predetermined schedule (i.e., instantly, daily, weekly, or monthly). Accordingly, service facilities will be able to use service records associated with the vehicle, including what service was performed, the service provider, where the service was performed, the parts used, the origin (or manufacturer) of those parts, and the warranty status of the parts. Records of service performed by a service facility registered with the system will be automatically exported from the service facility's point of sale or service management system into the database in an automated fashion (i.e., instantly, daily, weekly, or monthly). The service facilities will also be able to record vehicle inspection results for public consumption. The service facilities will, thus, be aware of upcoming recommended service schedules, which will allow them to remind their existing customers and facilitate maintenance scheduling.

These and other advantages will be apparent from the disclosure of the invention(s) contained herein. The above-described embodiments, objectives, and configurations are neither complete nor exhaustive. As will be appreciated, other embodiments of the invention are possible using, alone or in combination, one or more of the features set forth above or described in detail below. Further, the Summary of the Invention is neither intended nor should it be construed as being representative of the full extent and scope of the present invention. The present invention is set forth in various levels of detail in the Summary of the Invention, as well as, in the attached drawings and the Detailed Description of the invention and no limitation as to the scope of the present invention is intended to either the inclusion or non-inclusion of elements, components, etc. in this Summary of the Invention. Additional aspects of the present invention will become more readily apparent from the Detailed Description, particularly when taken together with the drawings.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participates in providing instructions to a processor for execution. Such a medium may take many forms, including but not limited to, non-volatile media, volatile media, and transmission media. Non-volatile media includes, for example, non-volatile random access memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a compact disc read only memory (CD-ROM), any other optical medium, punch cards, paper tape, any other physical medium with patterns of holes, a random access memory (RAM), a programmable read only memory (PROM), and erasable programmable read only memory (EPROM), a FLASH-EPROM, a solid state medium like a memory card, any other memory chip or cartridge, a carrier wave as described hereinafter, or any other medium from which a computer can read. A digital file attachment to an e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the embodiments of the present invention are considered to include a tangible storage medium or distribution medium and prior art-recognized equivalents and successor media, in which the software implementations of the invention are stored. It should be noted that any computer readable medium that is not a signal transmission may be considered non-transitory.

The term “module,” as used herein, refers to any known or later developed hardware, software, computer readable medium, firmware, artificial intelligence, fuzzy logic, or combination of hardware and software with functionality associated with a particular task and that is capable of performing the functionality associated with that task.

The terms “determine”, “calculate” and “compute,” and variations thereof, as used herein, are used interchangeably and include any type of methodology, process, mathematical operation or technique.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a communications/data processing network system that may be used in conjunction with embodiments of the present invention;

FIG. 2 is a data processing system that may be used in conjunction with embodiments of the present invention;

FIG. 3 is a diagram of an embodiment of a data structure for storing information about a vehicle that may be used in conjunction with embodiments of the present invention;

FIG. 4 is a block diagram illustrating users connecting to the system of the present invention; and

FIG. 5 is a flowchart of a method of tracking and reporting vehicle maintenance according to one embodiment of the present invention.

It should be understood that in certain instances, details that are not necessary for an understanding of the disclosure or that render other details difficult to perceive may have been omitted. It should be understood, of course, that the disclosure is not necessarily limited to the particular embodiments illustrated herein.

To assist in the understanding of one embodiment of the present invention the following list of components and associated numbering found in the drawings is provided:

| Number | Component |
|---|---|
| 100 | Vehicle maintenance tracking/reporting system |
| 105 | Computer |
| 110 | Computer |
| 115 | Computer |
| 120 | Network |
| 125 | Server |
| 130 | Server |
| 135 | Database |
| 200 | Data processing system |
| 205 | CPU |
| 210 | Input device |
| 215 | Output device |
| 220 | Storage device |
| 225 | Computer-readable storage media reader |
| 230 | Communication system |
| 235 | Processing acceleration unit |
| 240 | Memory |
| 245 | Operating system |
| 250 | Code/modules |
| 255 | Bus |
| 300 | Data structure |
| 304 | Vehicle record |
| 308 | Record number |
| 312 | Vehicle identifier |
| 316 | Vehicle information |
| 320 | Vehicle status |
| 324 | Vehicle grade |
| 328 | Owner information |
| 332 | Service record |
| 336 | Linked data |
| 340 | Other data |
| 344 | Ellipses |
| 404 | Owner |
| 408 | Service facility |
| 410 | Database |
| 412 | Potential buyer |
| 416 | Vehicle manufacturer |
| 418 | Database |
| 420 | Parts manufacturer |
| 422 | Database |
| 424 | Government agency |
| 426 | Database |
| 428 | Other users |
| 430 | Database |
| 434 | Vehicle |
| 500 | Method |
| 504 | Start |
| 508 | Create account |
| 512 | Register vehicle |
| 516 | Create vehicle record |
| 520 | Determine if service is required |
| 525 | Send service alert |
| 530 | Vehicle receives service |
| 535 | Enter service record |
| 540 | End |

### DETAILED DESCRIPTION

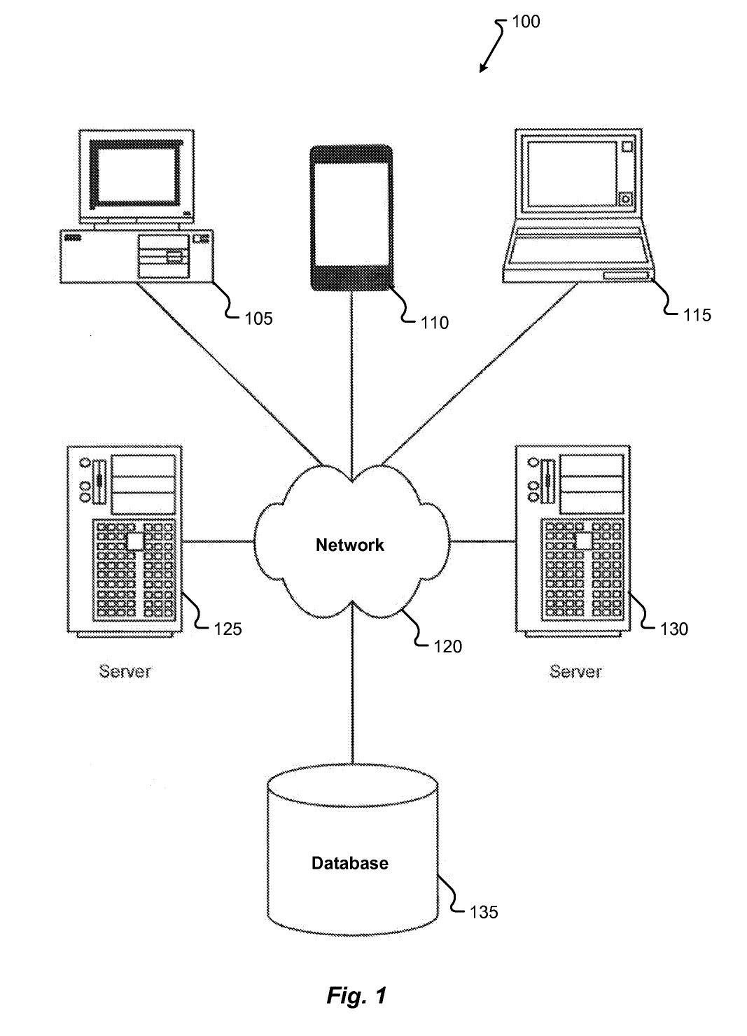

Referring now to FIG. 1, an example of a system 100 of tracking and reporting vehicle maintenance according to the present invention and methods disclosed herein is illustrated. More specifically, FIG. 1 illustrates a block diagram of a system 100 that includes one or more computers 105, 110, and 115. The computers 105, 110, and 115 may be general purpose personal computers (including, merely by way of example, personal computers and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These computers 105, 110, and 115 may also have any of a variety of applications, including for example, database client and/or server applications, and web browser applications. Alternatively, the computers 105, 110, and 115 may be any other electronic device, such as a client computer, laptop, Internet-enabled mobile telephone or smartphone, a computer built into a vehicle (including a computer or processor that monitors, records, and controls the vehicle's performance) and/or tablet computer, capable of communicating via a network (e.g., the network 120 described below), running programs and applications, and/or displaying and navigating web pages or other types of electronic documents. The computers may be operated by a vehicle owner, a vehicle service facility, or another registered user to access the system 100. Although the exemplary system 100 is shown with three computers, any number of user computers of any type may be supported.

System 100 further includes a network 120. The network 120 may be any type of network familiar to those skilled in the art that can support data communications using any of a variety of commercially-available protocols, including without limitation TCP/IP, SNA, IPX, AppleTalk, and the like. Merely by way of example, the network 120 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a vehicle communication system, such as OnStar™; a wireless network (e.g., a network operating under any of the IEEE 802.11 suite of protocols, the Bluetooth™ protocol known in the art, and/or any other wireless protocol); and/or any combination of these and/or other networks.

The system 100 may also include one or more server computers 125, 130. One server may be a web server 125, which may be used to process requests for web pages or other electronic documents from computers 105, 110, and 115. The web server can be running an operating system including any of those discussed above, as well as any commercially-available server operating systems. The web server 125 can also run a variety of server applications, including HTTP servers, FTP servers, CGI servers, database servers, Java servers, and the like. In some instances, the web server 125 may publish operations available as one or more web services.

The system 100 may also include one or more file and/or application servers 130, which can, in addition to an operating system, include one or more applications accessible by a client running on one or more of the computers 105, 110, and 115. The server(s) 130 may be one or more general purpose computers capable of executing programs or scripts in response to the computers 105, 110 and 115. As one example, the server may execute one or more web applications. The web application may be implemented as one or more scripts or programs written in any programming language, such as Java™, C, C#™ or C++, and/or any scripting language, such as Perl, Python, or TCL, as well as combinations of any programming/scripting languages. The application server(s) 130 may also include database servers, including without limitation those commercially available from Oracle, Microsoft, Sybase™, IBM™ and the like, which can process requests from database clients running on a computer 105.

In some embodiments, an application server 130 may create web pages dynamically for displaying user interfaces for registering users, displaying vehicle service records, entering information into the vehicle service records, searching for vehicles, searching for service facilities, etc. The web pages created by the web application server 130 may be forwarded to a computer 105, 110 and 115 via a web server 125. Similarly, the web server 125 may be able to receive web page requests, web service invocations, and/or input data from a computer 105, 110 and 115 and can forward the web page requests and/or input data to the web application server 130.

In further embodiments, the server 130 may function as a file server. Although for ease of description, FIG. 1 illustrates a separate web server 125 and file/application server 130, those skilled in the art will recognize that the functions described with respect to servers 125, 130 may be performed by a single server and/or a plurality of specialized servers, depending on implementation-specific needs and parameters.

The system 100 may also include a database 135. The database 135 may reside in a variety of locations. By way of example, database 135 may reside on a storage medium local to (and/or resident in) one or more of the computers 105, 110, 115, 125, 130. Alternatively, it may be remote from any or all of the computers 105, 110, 115, 125, 130, and in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10i™, that is adapted to store, update, and retrieve data in response to SQL-formatted commands.

The system 100 of one embodiment collects and stores vehicle service records after the service records are entered by a registered, authorized, and authenticated user. The system 100 stores the service records in database 135. The service records may be organized using one or more unique identifiers for each vehicle, such as the vehicle identification number (VIN), or the owner's name.

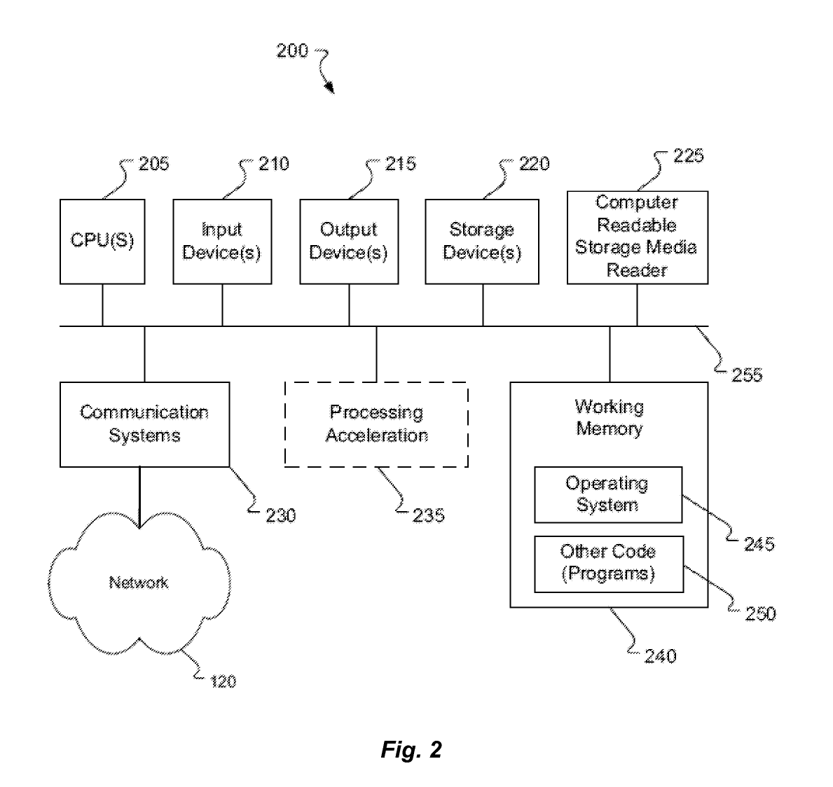

Referring now to FIG. 2, an example data-processing system is provided that may be used in connection with the vehicle maintenance tracking and reporting system 100 of the present invention. More specifically, FIG. 2 illustrates one embodiment of a data-processing system 200 upon which the system 100 or components of the system may be deployed or executed. The data-processing system 200 is shown comprising hardware elements that may be electrically coupled via a bus 255. The hardware elements may include one or more central processing units (CPUs) 205; one or more input devices 210 (e.g., a mouse, a keyboard, etc.); and one or more output devices 215 (e.g., a display device, a printer, etc.). The data-processing system 200 may also include one or more storage devices 220 such as disk drives, optical storage devices, solid-state storage device such as a random access memory (“RAM”) and/or a read-only memory (“ROM”), which can be programmable, flash-updateable and/or the like.

The data-processing system 200 may additionally include a computer-readable storage media reader 225; a communications system 230 (e.g., a modem, a network card (wireless or wired), an infra-red communication device, etc.); and working memory 240, which may include RAM and ROM devices as described above. In some embodiments, the data-processing system 200 may also include a processing acceleration unit 235, which can include a DSP, a special-purpose processor and/or the like.

The computer-readable storage media reader 225 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 120 and/or any other data-processing systems described above with respect to the system 100.

The data-processing system 200 may also comprise software elements, shown as being currently located within the working memory 240, including an operating system 245 and/or other code 250, such as program code implementing system 100 or components of the system. It should be appreciated that alternate embodiments of a data-processing system 200 may have numerous variations from that described above. For example, customized hardware might also be used and/or particular elements might be implemented in hardware, software (including portable software, such as applets), or both. Further, connection to other computing devices such as network input/output devices may be employed.

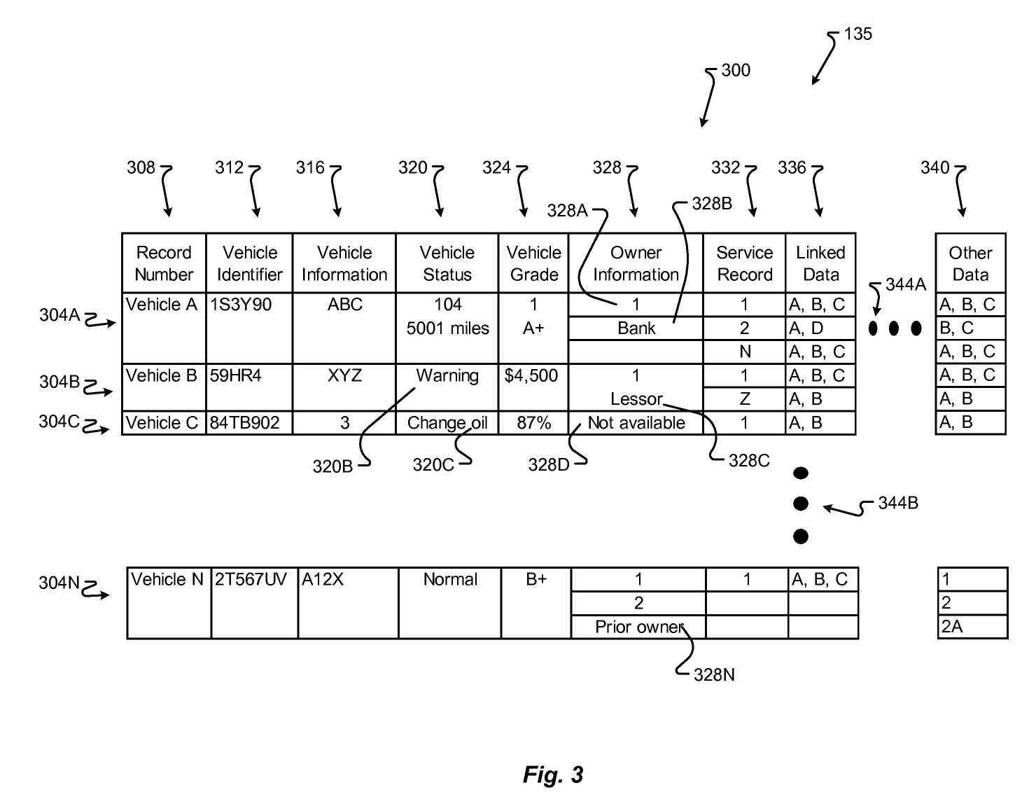

Referring now to FIG. 3, an embodiment of a data structure 300 of the database 135 is illustrated. As will be recognized by one of skill in the art, the database 135 may include any number of data structures to organize and store information about vehicles. The data structure 300 contains records 304A . . . 304N for a plurality of vehicles. Each record 304 has a plurality of data fields 308-340 representing different types of data associated with each vehicle. Additionally, each data field may include a plurality of additional records. The fields may include, but are not limited to: a record number 308, a unique vehicle identifier 312; vehicle information 316; vehicle status information 320; a vehicle grade 324; owner information 328; service records 332; linked data 336; and other data 340. As will be appreciated by one of skill in the art, the data structure 300 may include any number of additional data fields, as represented by ellipses 344A. Further, additional records 304 for more vehicles may be added to the data structure 300 by users as represented by ellipses 344B.

The record number 308 is used by the data structure 300 to organize vehicle records 304. The vehicle identifier 312 field may include any combination of letters or numbers to uniquely identify each vehicle record 304 in the data structure 300. In one embodiment, the vehicle identifier 312 may be the Vehicle Identification Number (VIN) used by the automotive industry to identify individual vehicles. As will be recognized by one of skill in the art, a vehicle's VIN is defined by International Organization for Standardization (ISO) standard 3833.

The vehicle information 316 field may include information such as, but not limited to the make, model, year, color, attributes, serial numbers of original parts, and accessories of the vehicle. The vehicle information 316 may also include information such as a license plate number, registration information, vehicle title information, insurance information, and pictures of the vehicle.

The vehicle status 320 field generally includes information received from a registered user or automatically received from a computer associated with the vehicle. The vehicle status 320 may generally include vehicle mileage, recorded gas mileage, and vehicle location. The system 100 may also receive a store readings from vehicle sensors, such as engine temperature, oil temperature, oil level, oil life remaining, tire pressure, engine diagnostic sensors, fault indicators, error codes, maintenance codes, collision indicators, air bag status, and vehicle emission status. For example, record 304B includes a warning indication in portion 320B. Record 304C indicates in portion 320C that the oil of vehicle C should be changed. The oil change indication may be determined based upon a signal received from a sensor in vehicle C or based on the mileage elapsed since a previous oil change. As will be recognized by those of skill in the art, any other information from any other sensor associated with the vehicle may be received by the system 100 and stored in the vehicle status 320 field. The status information by comprise any number of individual records and include date and time stamps to allow an analysis of the vehicle status 320 data over time.

The data structure 300 of database 135 may optionally include a grade 324 representing the quality and/or perceived health of a vehicle. The grade 324 may be one or more of a letter, a number, and a symbol. In one embodiment, the grade 324 may be calculated by one or more predetermined algorithms using a plurality of data points obtained from the plurality of data fields in the data structure 300 for the vehicle. In one embodiment, the grade may be determined by the system 100 by comparing service records 332 for the vehicle to the manufacturer's recommended maintenance schedule. The system 100 may also consider the frequency of service performed on the vehicle to determine the grade 324. For example, the system 100 may rate frequent preventative maintenance favorably and improve the grade. In contrast, service to repair failures or damage to the vehicle may be used by the system 100 to decrease the grade. Further, the system 100 may consider the type of service when determining the grade. Accordingly, certain service, whether preventive or failure repairs, may be weighed differently by the system 100 to determine the grade Thus a routine oil change may have a slight positive effect on the grade while a timing belt change recommended by the vehicle manufacturer may have a large positive effect on the grade. In contrast, a transmission malfunction may result in a substantial negative effect on the grade.

In another embodiment, the system 100 may determine the grade 324 by comparing the service records 332 of the vehicle to service records of other vehicles of the same or similar year, make, or model. Thus, the system 100 can determine if the vehicle has required more maintenance than other vehicles of a similar or same year, make, and model. If the vehicle has required more maintenance than other similar vehicles, the system 100 can decrease the grade of the vehicle.

Additionally or alternatively, the system 100 may consider a rating entered by a registered service facility when determining the grade 324. In another embodiment, the grade may comprise an average of ratings of the vehicle supplied by one or more registered service facilities that have serviced the vehicle. In yet another embodiment, the grade 324 is an estimated value of the vehicle determined by the system 100. Still further, the system 100 may determine the grade based on information received from other users, including insurers, vehicle owners, and manufacturers.

The owner information 328 field may include information about owners of a vehicle, including a name, mailing address, billing address, phone number, email address, and owner interest type. Preferences of the owner, such as a preferred contact method for alerts generated by the system, may also be stored in field 328.

The data structure 300 can store information for more than one owner associated with a vehicle in field 328. For example, as illustrated in FIG. 3, vehicle A has two owners 328A, 328B. Owner 328A is an individual person. The second owner 328B is identified as a legal entity and, in this example, is an internet service provider. Vehicle B also includes an institutional owner 328C identified as a lessor. Identifying an institutional owner such as bank or lessor may be useful to a service facility to prevent performing service that is prohibited or requires prior authorization from the institutional owner. The owner information 328 field may also store information related to a previous owner, such as previous owner 328N of vehicle N.

In one embodiment, when the vehicle owner registers with the system 100, the vehicle owner can provide access to one or more data fields in the data structure 300 to other users. In another embodiment, the vehicle owner 328 may limit or prevent access to one or more data fields for predetermined users. For example, record 304N identifies three owners. Owner 1 may be the majority owner of vehicle N. Accordingly, owner 1 may prevent access to, or limit the rights of, owner 2 and the prior owner of vehicle N. In another example, bank 328B may prevent access, or limit the rights of, owner 1 328A of vehicle A.

When the identity of a vehicle owner is not known, the data structure 300 may indicate that the information is not available, as illustrated in portion 328D of record 304C. A registered service facility that services vehicle C may complete portion 328D when uploading a service record 332 for the vehicle. Alternatively, the owner may complete portion 328D when registering with the system 100.

Each vehicle record 304 may include any number of service records 332. For example, vehicle record 304A of Vehicle A includes service records 332 for service events 1 . . . N. Each service record 332 may include, but is not limited to: date service performed; type of service performed (including one or more fields for comments, a written description of the work, whether the service was preventative or for due to a part failure or vehicle damage, and/or images or pictures to describe the service performed); identity and location of service provider; name of service technician; parts used (further including serial number, source, manufacturer, date of manufacture, and warranty of the parts); date, location and results of government inspections or tests; results of diagnostic tests performed by the service facility; identification of the person or service facility entering the service record into data structure 300; and receipts or other attachments that are relevant to the service record (includes costs of parts and labor). The diagnostic tests may be for any type of test performed by the service facility, including wheel alignment, braking function, measurement of brake pads, tire tread remaining, engine function, and emission control system function.

In an embodiment, the service record 332 may optionally include one or more fields to record a description of condition of the vehicle, such as a service technician's rating of the safety or appearance of the vehicle. The service technician's rating may be used by the system 100 to determine the vehicle grade 324, as described above.

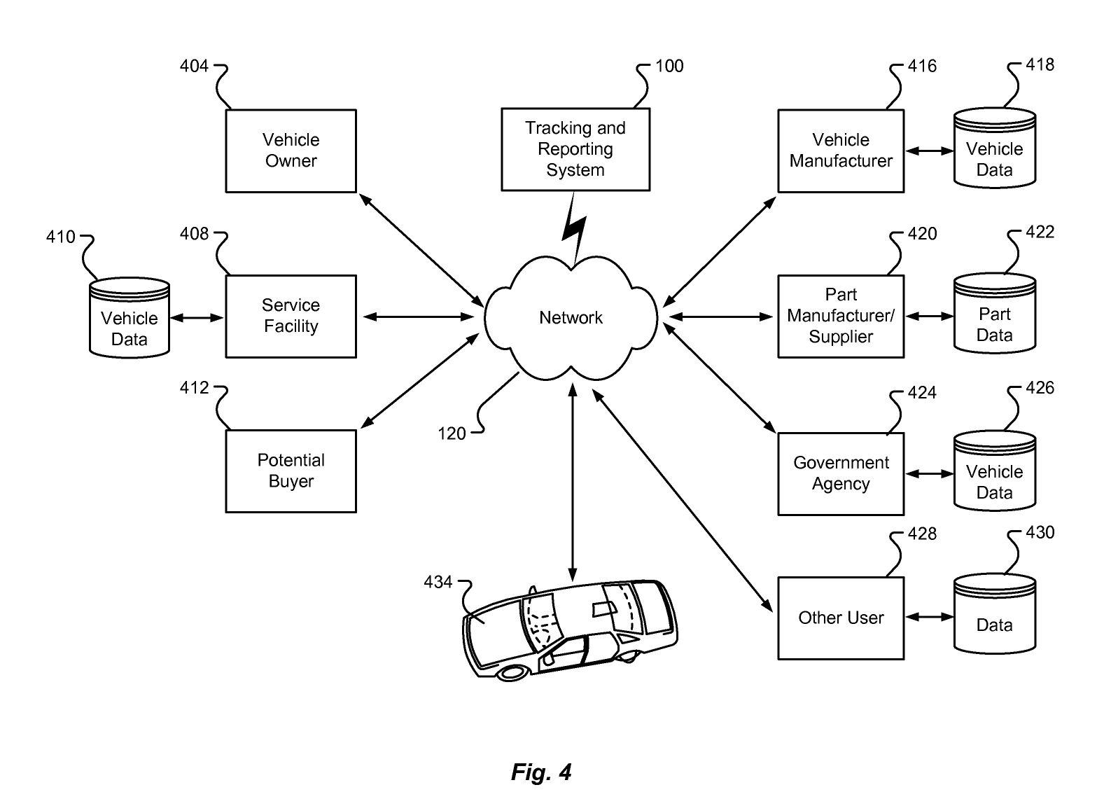

One or more additional data fields may be stored in the linked data portion 336 as data or locations of data. The linked data 336 may include pointers, addresses, location identification, data source information, and other information corresponding to additional data associated with a vehicle record 304 in data structure 300. Optionally, the linked data 336 may refer to data stored outside of data structure 300. For example, the linked data 336 may include a link/locator to data stored in another data structure of database 135 or to external data stored or provided by a different system accessible by network 120. The system 100 may use the network 120 to access data stored by the different system operated by vehicle manufacturers, government agencies, parts manufacturers and suppliers, among others, as described in more detail below in conjunction with FIG. 4.

Referring now to FIG. 4, any number of users may send information to, and receive information from, the system 100. A user, such as, but not limited to, a vehicle owner 404, a vehicle service facility employee 408, a potential buyer 412 of a vehicle, a vehicle manufacturer 416, a parts supplier or manufacturer 420, a government agency 424, and other users 428 may access the system 100 using a computer 105, 110, 115. For example, a user may access system 100 through an internet connection over network 120. A user may also access the system via an app stored on a mobile electronic device such as a smart-phone 110, or via a computer 105, 110, 115 built into a vehicle 434 using a network 120 such as Bluetooth™ or OnStar™.

In one embodiment, a computer 105, 110, 115 built into a registered vehicle 434 may be able to automatically provide vehicle status information 320 using a network 120 such as a WiFi connection, Bluetooth™ or OnStar™ to update information stored in the database 135. The update may be provided by a machine-to-machine interface. Thus, the vehicle's computer 105, 110, 115 may automatically, or on a predetermined schedule, provide vehicle status information 320 to database 135 such as, but not limited to: vehicle mileage; vehicle location; readings from vehicle sensors (i.e., engine temperature, oil temperature, oil level, oil life remaining, tire pressure, engine diagnostic sensors, fault indicators, error codes, maintenance codes, collision indicators, air bag status, vehicle emission status); and information from any other sensor built into the vehicle 434.

Users may create accounts in system 100 to obtain access to various records maintained in database 135. To ensure security and data integrity, all users may be required to create a user identification (user id) and a password to create an account on the system 100. Users may be required to authenticate their identity using the user id and password each time they access the system 100 by any method known in the art.

Different types of users may be given different authorities over, and access to, information stored in database 135. In one embodiment, the level of access of a user may be determined by the type of user. Some types of users may review more information, and have more authority to enter or change information, than other users. For example, the vehicle owner 404 may be able to enter, review, change or delete information in database 135 related to a vehicle 434 owned by the owner. In another example, service facilities 408 have unlimited access to search for and view vehicle records 304 in data structure 300 after registering with the system 100. In contrast, a potential buyer 412 or government agency 424 may have only limited access to the system 100. Additionally, manufacturers 416, 420 may be able to view information but not change any information in data structure 300. Various users 408, 412, 416, 420, 424, 428 may also use the system 100 to communicate with the vehicle owner 404.

In one embodiment, the level of access of a user may be determined by a subscription level purchased by the user. For example, a vehicle owner 404 may be able to view limited information (such as only service records 332) associated with a record 304 of the owner's vehicle for free. However, the vehicle owner 404 may only be allowed to view other information, upload information to data structure 300, or control access to information by other users after purchasing a subscription to the system 100. In one embodiment, the subscription may provide a predefined level of access for a particular period of time. In another embodiment, a fee for the subscription may vary based on the frequency or level of use of the user. In still another embodiment, service facilities 408 are not charged a fee to register with the system 100 or to search for and view vehicle records 304 in data structure 300.

Optionally, some types of users may be required to purchase a subscription to receive access to system 100 and database 135. For example, in one embodiment, potential buyers 412 may be required to purchase a subscription to register an account on system 100 before receiving access to database 135. Vehicle manufacturers 416 may also be required to purchase a subscription for access to the system 100. In another embodiment, users may receive a partial or complete discount of the subscription fee in return for allowing the system 100 to access the user's database 410, 418, 422, 426, 430.

Once a user has registered with the system 100, the user may access information stored in database 135 over network 120, including the internet, using any type of computer 105, 110, 115, including an application or software running on a smart phone, tablet computer, a computer built into a vehicle, or any other type of mobile communication or computing device.

A vehicle owner may use a computer 105, 110, 115 to create an account on the system 100 that allows the owner to register a vehicle. An owner may create accounts for one or more vehicles and, after registering the vehicle in system 100, the owner may enter data about maintenance which the vehicle owner has personally performed, or has had performed, on the vehicle. The maintenance data may include receipts for parts or service performed, pictures illustrating work performed or damage observed, and a written or oral description of the work performed. The maintenance data may be uploaded as a scanned document file or a photo file of a receipt or a maintenance record. The system 100 may then perform an optical character recognition of the file and automatically extract information from the file to update the maintenance record into one or more fields of the data structure 300 in the database 135.

In one embodiment, the vehicle owner may view all information in the database 135 related to vehicles the user has registered. The information may include vehicle service records 332 entered by a previous vehicle owner, by one or more service centers 408, and by the vehicle owner 404. A registered vehicle owner may receive an alert by email, phone call, text message, or a Tweet™ when a service record 332 is uploaded into database 135 for the owner's vehicle. Thus, the owner can review new vehicle service records, look for errors and discrepancies in them, and provide comments. In one embodiment, the vehicle owner may optionally be able to enter comments about service performed by a technician of a service facility 408 in relation to a service record 332. However, the vehicle owner may not delete or alter the service record 332 entered by the service facility. The vehicle owner 404 may also receive an alert whenever another user reviews or accesses a record 304 of the owner's vehicle. For example, the vehicle owner 404 may receive an email or text message when a potential buyer 412 views information about the owner's vehicle in data structure 300.

A service record may be disputed by the owner when, for example, the owner identifies improperly entered, erroneous, false, or fraudulent service records. The owner may use the system 100 to contact the service facility 408 that uploaded the disputed record 332. When a service record is disputed, the service facility may correct the disputed record or provide comments to explain why the record is correct. If the owner is not satisfied with the response, the owner may provide additional comments in a comment field of the database 135. The owner may also contact a system administrator and request that the disputed record be removed from the database 135. The system administrator may then review the file and determine if the service record 332 should be removed from the database 135.

The vehicle owner 404 may use the system 100 to access and review factory or manufacturer recommended preventative maintenance for a registered vehicle. The system 100 may also provide alerts to the vehicle owner 404 about vehicle manufacturer recalls or recalls of parts installed on the vehicle 434. For example, some replacement parts or components may be subject to recalls and warnings separate from the vehicle itself. If the replacement parts are entered in a vehicle service record 332 of the data structure 300 for a vehicle registered by the owner, the system 100 can provide a warning or notice if a replacement part is recalled after installation in the vehicle.

By registering with the system 100, the vehicle owner 404 may also receive access to other features of the system. In an embodiment, the system 100 may optionally send emails, voice messages to an owner's phone number, and/or text message reminders to the vehicle owner when recommended preventative maintenance is due or expected to be due based upon one or more of the age or mileage of the vehicle. In another embodiment of the present invention, the system 100 may evaluate the vehicle information 316 and service records 332 for a vehicle 434. The system 100 may then retrieve recommended service information from the vehicle manufacturer 416 to determine that the vehicle needs service. Additionally, the system 100 may determine that the vehicle 434 is experiencing a malfunction based on vehicle status information 320 received from a sensor or fault indicator of the vehicle. Accordingly, the system 100 can send a message to the owner 404 recommending routine or repair service. The message may include a list of recommended service facilities, such as but not limited to service facilities registered with the system. Additionally, the message may include: a list of parts, brands of parts, labor required for the service, and an itemized estimate of the cost of the parts and labor required for the service. The system 100 may send messages and alerts to registered users by any method, including without limitation, by a letter mailed to an address of the user, a telephone call (including an automated or computer generated message), an email, a text message, or a tweet.

The system 100 can provide the vehicle owner with a list or directory of local service facilities 408 which have created accounts on the system 100 so that service performed on the owner's vehicle may be entered into database 135 by the service facility. In one embodiment, an app running on a smart-phone 110 or a computer 105, 110, 115 built into a vehicle may be used to access the system 100. The app or computer may use the vehicle's location to automatically find service facilities that have an account on the system 100 within a predetermined radius of the owner or the vehicle. The user may then select a service facility and the app may automatically schedule an appointment for vehicle service with the selected service facility. In one embodiment, one or more a registered service facilities or service facility franchises may be designated by a user as a favorite. The app may then locate the closest favorite service facility or favorite service facility franchise and schedule an appointment with the service facility and provide directions to the service facility. After the user selects a service facility, the app may use a display screen of the mobile electronic device or computer built into a vehicle to provide directions and a map to the service facility.

Institutional owners 404, such as banks and lessors, may also register with the system 100 to monitor the status of vehicles they own or have rights to. Accordingly, institutional owners can review the service records 332 of a vehicle to ensure required periodic service is being performed by the owner. Institutional owners may also review status information 320 to monitor the mileage of the vehicle or the location of the vehicle if relevant to a lending agreement or lease agreement.

A vehicle owner can transfer the registration of a vehicle in the system 100 to another registered owner. For example, if a vehicle owner sales a registered vehicle, the original vehicle owner may release the vehicle in the system 100 so that the purchasing user can claim ownership of the vehicle and acquire all of the rights of a vehicle owner in the system.

Vehicle service facilities 408 may also create accounts with the system 100. Service technicians of service facilities may then review the maintenance records of a registered vehicle stored in the data structure 300 of database 135 before performing work on the vehicle. The service technician can use the VIN to search for a vehicle record 304 in the data structure 300. The service facility may have access to and be able to review records of work performed on the vehicle including details about types of service performed, where service was performed, what parts were used, where the parts were obtained, and warranty status of those parts. Service technicians can also review results of diagnostic tests previously performed on the vehicle. This may increase the efficiency of the service technicians and the vehicle service facility by allowing the service technicians to skip unnecessary inspections and quickly identify components that may need service or replacement based on manufacturer recommendations. The service technicians may also use the system 100 to review recall information for parts and components installed on a registered vehicle. Service facilities can also create a record 304 in the data structure 300 for an unregistered vehicle (for example, when the data structure 300 does not include a record for the vehicle). In one embodiment, employees of the service facilities 408 may access and review all fields in a vehicle record 304 of data structure 300 except for the cost of service performed by a different service facility. In another embodiment, service facilities 408 receive unlimited free access to data structure 300 after registering with the system.

A service facility 408 franchise can also create accounts with the system 100. Franchises may be provided access to database 135 to review service history performed by franchisees, for example, to determine the quality of work performed by individual franchisees. In one embodiment, the franchise can use the system 100 to compare the quality of work, efficiency, and owner reviews of franchise facilities. Franchises can also use the system 100 to compare performance of franchise facilities to other service facilities.

Potential vehicle buyers 412 may register with the system 100 to obtain access to vehicle records in database 135. In one embodiment, potential buyers 412 are required to pay a fee to receive access to the system 100. The vehicle buyers may search for individual vehicles and then review various fields of data structure 300. In an embodiment, a vehicle buyer may have access to all fields in data structure 300. In another embodiment, the buyer may receive certain information for a vehicle including, but not limited to: the service history of vehicles; maintenance performed including the date, location, technician, and the service receipt; parts used to perform repairs including serial numbers, brands, and the warranty status of parts used. Vehicle buyers may also be able to access the grade 324 field of data structure 300.

The system 100 may provide a user interface with a text field for the potential buyer 412 to write a message to the vehicle owner 404. The system 100 may then send the message to the vehicle owner. The owner may then receive the message with a text field to write a response to the potential buyer. Thus, the system 100 enables potential buyers to send and receive messages to one or more vehicle owners.

In one embodiment, the potential buyer 412 may not view vehicle status 320 information. In another embodiment, the potential buyer may view vehicle mileage information stored in the vehicle status 320 field. In still another embodiment, the system 100 may prevent the potential buyer from viewing information on an individual owner in the owner information 328 field. The system 100 may allow the potential buyer 412 to view information related to an institutional owner, such as a bank or other lender, or a lessor.

In one embodiment, vehicle manufacturers 416 may be able to access database 135 to review service records 332 of individual vehicle models or entire brands to identify malfunction trends and reliability histories and for other reasons. For example, in one embodiment of the present invention, the system 100 can compare service records of some or all vehicles in the data structure 300. The system 100 can then provide information to manufacturers 416 and other uses such as the reliability of certain years, makes, or models of vehicles compared to other vehicles. The system 100 can also determine cost, frequency, and time required to service vehicles of any year, make, or model compared to other vehicles. The system can also determine if certain vehicles require or receive more service (either preventative or due to failure) than other vehicles. Additionally, in another embodiment, the user can select vehicles of a particular year, make, and/or model for comparison by the system 100 to other selected vehicles. Vehicle manufacturers 416 may also review the vehicle location in the vehicle status field 320 to determine where particular types or makes of vehicles are located for marketing and sales purposes. In one embodiment, one vehicle manufacturer may not review information in database 135 related to vehicles manufactured by others. In another embodiment, one vehicle manufacturer can review information related to vehicles of any manufacturer.

Part manufacturers 420 (including original and replacement part manufacturers and part suppliers) can register with the system 100. The system 100 enables part manufacturers 420 to track parts to determine the reliability and the mean time between failures of parts. Parts manufacturers may also use the system to notify registered users of recalled parts that have been installed on a registered vehicle 434 that should be inspected or replaced. Users may also use the system 100 to access a database 422 of the part manufacturer 420 to review serial numbers of parts to identify if parts identified as new have previously been installed in other vehicles and are thus actually used parts. In addition, users can search serial numbers of parts to ensure they are genuine parts and not counterfeits.

Other users 428 may also register with the system 100. For example, vehicle insurers, researchers, appraisers, and other entities may access and provide data to the system.

The system 100 may use network 120 to automatically retrieve information from one or more registered users. In one embodiment, the vehicle 434 may automatically transmit vehicle status 320 data at predetermined times, or substantially continuously, to the system 100 using network 120. Additionally, vehicle status 320 data may be downloaded from a computer associated with the vehicle 434 by a technician of a service facility 408 performing work on the vehicle. The service facility 408 can then transmit the status data to the system 100.

The system 100 can also automatically retrieve information for various fields 308 . . . 340 of data structure 300. For example, in one embodiment of the present invention, after the VIN of a vehicle 434 is entered in the vehicle identifier 312, the system 100 may connect to a computer 105 operated by the vehicle's manufacturer 416. The system 100 can then search for and retrieve information about the vehicle stored in the manufacturer's database 418. The system 100 may also use one or more of the VIN and the license plate number to retrieve information such as title information, license or registration information, and government inspection status (such as safety inspections, smog (or exhaust) inspection results) from a database 426 of a government agency 424.

Further, when one user, such as a service facility, creates a record for a vehicle in data structure 300, the system 100 may retrieve information to complete the service record 332 field of data structure 300 from databases 410 of other service facilities. The system 100 can also automatically retrieve owner information 328 for a vehicle using the VIN and/or license number from databases 410, 426 of one or more other users 408, 424.

After performing work on a registered vehicle, a service technician of a registered service facility 408 may enter service records 332 for work performed on the vehicle into the database 135. The service records may also be automatically exported from the service facility at the point of sale. Alternatively, the service records can be automatically exported from a database 410 of the service facility 408 or by the service facility's service management system or local computer network into the system 100 and database 135 through an automated, machine-in-machine, interface. The service records may be exported to system 100 instantly (for example, as generated by the service facility) or on a periodic schedule, such as daily, weekly, or monthly.

A registered service facility may also record vehicle inspection results for a registered vehicle in the system 100 for use by authorized government agencies 424. For example, some states and other government agencies require vehicles to pass periodic exhaust emission requirements. A registered service facility 408 could enter the results of an exhaust emission test into the system 100 where it could be available for review by authorized government officials. Other government agencies require periodic vehicle safety inspections which could be recorded in system 100 by a registered service facility.

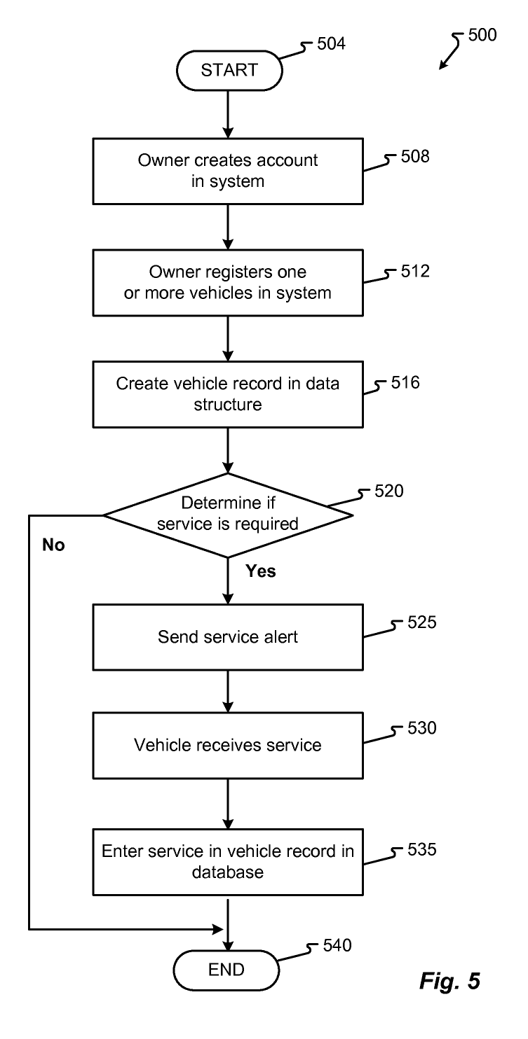

An embodiment of a method 500 for tracking and reporting vehicle maintenance is illustrated in FIG. 5. A general order for the steps of the method 500 is shown in FIG. 5. Generally, the method 500 starts with a start operation 504 and ends with an end operation 540. The method 500 can include more or fewer steps or can arrange the order of the steps differently than those shown in FIG. 5. Accordingly, it should be appreciated that changes, additions, and omissions to this sequence can occur without materially affecting the operation of the disclosed embodiments, configuration, and aspects of the invention. The method 500 can be executed as a set of computer-executable instructions executed by a computer system and encoded or stored on a computer readable medium, such as 200. Hereinafter, the method 500 shall be explained with reference to the systems, components, modules, software, data structures, user interfaces, etc. described in conjunction with FIGS. 1-4.

A vehicle owner 404 initially creates an account 508 with system 100 at step 508. When creating the account, the owner may enter contact information such as a phone number or email address into the system 100 to receive automatic notices of scheduled or expected maintenance for a registered vehicle. The vehicle owner may then register one or more vehicles 434 with system 100 at step 512. The system 100, a step 516, then creates a vehicle record 304 associated with the vehicle owner 404 in data structure 300. The system 100 may generate one or more user interfaces requesting information about the vehicle 434 for entry by the owner. For example, the vehicle owner may receive prompts to enter information about the vehicle (make, model, year, type, mileage, VIN, etc.) and prior maintenance records 332 in data structure 300. When creating the vehicle record 304, the system 100 may also automatically retrieve data from one or more databases 410, 418, 422, 426, 430 as described above.

In step 520, the system 100 determine if service is suggested or required. As described above, the system 100 can review the vehicle status 320 and service record 332 of the vehicle 434. The system 100 compares odometer readings with suggested maintenance data received from the vehicle manufacturer 416 and determine that periodic maintenance is required. If no record of the periodic maintenance is recorded in the service record 332, the system can determine that the vehicle 434 is due for periodic maintenance. Additionally, the system 100 may receive new status information 320 from the vehicle indicating a fault or a sensor reading indicating service is required. The system 100 may also determine scheduled or required service is suggested or recommended for the vehicle based on the age of the vehicle, mileage, or a recall notice. Of course, the owner may also determine the vehicle requires service without receiving a notice from system 100. If the system 100 determines service is required, method 500 proceeds YES to step 525. If service is not required, method 500 proceeds NO to end 540.

If the vehicle needs service, the system 100 may send an alert 525 to the owner in step 525. The alert can be an audio or text message as previously described. Optionally, in one embodiment, the method of providing the alert may be selected based on the type of service required. For example, for a less important routine service event, the system may provide the alert using one or more of a physical letter to an address of the owner or an email. For a more urgent service event, the system 100 may sent by a text message, a computer generated phone call to the owner, or a Tweet. Additionally or alternatively, the owner may selected a desired notification method for receiving service alerts when creating the account in step 508.

The system 100 may also send a service alert to one or more service facilities 408 that have provided service to the vehicle 434 or that have been selected by the owner during account creation. The service facility may then contact the owner to schedule the service, or offer a discount associated with the service to entice the vehicle owner to schedule service. Alternatively, the owner may search system 100 for a service facility that is registered with and uses system 100. The owner may then take the vehicle to a registered service facility or an unregistered service facility.

Repairs or service may then be performed on the vehicle in step 530. After repairs or service are performed on the vehicle, a record of the repairs or service may be entered into database 135 in step 535. If the repair or service were performed by a registered service facility, the record of the repairs or service may automatically be entered into database 135 by the registered service facility. If the owner did not take the vehicle to a registered service facility, after repairs or service are performed the owner may enter a record of the repairs or service into database 135. The owner may scan or take a picture of a receipt or other service record to create an electronic file that may be uploaded into the system 100. The system may then automatically extract information from the electronic file to update the service record 332 in data structure 300. The record of repairs or service may include information such as the date of the service, vehicle mileage, where the service was performed, a name of the service technician, parts installed on the vehicle, a brand or manufacturer of the parts, a serial number of the parts, warranty information of the parts, images or photos illustrating repairs or damage noticed or repaired, comments describing the service, maintenance, or repairs, comments describing overall condition or service status or history of the vehicle, copies of receipts or invoices, and other such information. The method 500 may then repeat as the registered vehicle receives service or when the system 100 determines, in step 520, that service is again required or suggested.

While various embodiments of the present invention have been described in detail, it is apparent that modifications and alterations of those embodiments will occur to those skilled in the art. However, it is to be expressly understood that such modifications and alterations are within the scope and spirit of the present disclosure. For example, alternatively, or in addition, the system of the present invention may include aspects of inventions disclosed in U.S. patent and Published U.S. Pat. Nos. 6,308,120, 2008/0103806, and 2002/0091706, all of which are incorporated herein by reference in their entireties. Additionally, aspects of inventions disclosed in U.S. patent and Published U.S. Pat. Nos. 6,529,620, 7,142,959, 7,739,007, 7,877,176, 8,095,265, 8,155,817, 8,209,076, 8,311,698, and 2002/0016655, which are each incorporated herein by this reference, may be incorporated into embodiments of the present invention.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Furthermore, while the exemplary aspects, embodiments, options, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a Personal Computer (PC), laptop, netbook, smart phone, Personal Digital Assistant (PDA), tablet, etc., or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

In the foregoing description, for the purposes of illustration, methods were described in a particular order. It should be appreciated that in alternate embodiments, the methods may be performed in a different order than that described, and that changes, additions, and omissions to the order of the methods can occur without materially affecting the operation of the disclosed embodiments, configurations, and aspects of the invention. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Optionally, the systems and methods of this invention can be implemented in conjunction with a special purpose computer, a special purpose data-processing system, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Further, the invention(s) described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. A method of tracking and recording vehicle maintenance, the method comprising the steps of:
providing a system for tracking and recording vehicle maintenance comprising:
one or more computers;
a network;
a web server;
a file server;
an application server; and
a database in communication with the one or more computers, the
network, the web server, and the file and application server;
creating an account with the system;
registering a vehicle in the system;
entering information about the vehicle into the database; and
entering vehicle maintenance information about the vehicle into the database.

2. A system for tracking and recording vehicle maintenance, the system comprising:
one or more computers;
a network;
a web server;
a file server and an application server;
a database in communication with the one or more computers, the network, the web server, and the file and application server, the system operable to:
receive a request to create an account for a vehicle owner;
create an account for the vehicle owner;
receive a request to register a vehicle with the vehicle owner's account;
create a record in the database for the registered vehicle;
receive information about the registered vehicle from the vehicle owner;
store the information about the registered vehicle in the database;
receive a request to create an account for a vehicle service center;
create an account for the vehicle service center;
receive second information about the registered vehicle from the vehicle service center; and
store the second information in the database.

3. A non-transitory computer readable medium, having stored thereon, computer-executable instructions executable by a processor of a vehicle tracking and maintenance system, the computer-executable instructions causing the processor to execute a method, the computer-executable instructions comprising:
instructions to receive a registration request from a service facility;
instructions to create an account for the service facility in the system;
instructions to receive a request for a vehicle record of a vehicle from the service facility;
instructions to determine if a database of the system includes the vehicle record;
if the database includes the vehicle record, instructions to present the vehicle record to the service facility;
if the database does not include the vehicle record, instructions to create the vehicle record for the vehicle in the database, wherein the vehicle record includes first information received from the service facility;
instructions to modify the vehicle record with second information received from the service facility after the service facility performs service on the vehicle, wherein the second information includes at least one of a type of service performed, a part installed on the vehicle, and a receipt for the service performed.
